(19) United States
(12) Patent Application Publication
(10) Pub. No.: US 2007/0140473 A1
(43) Pub. Date: Jun. 21, 2007

(54) Bidirectional transmission device and bidirectional transmission method

(75) Inventor: Manabu Ishibe, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA.

(21) Appl. No.: 11/586,677

(22) Filed: Oct. 26, 2006

(30) Foreign Application Priority Data
Dec. 21, 2005 (JP) 2005-368104

(51) Int. Cl. H04M 9/00; H04M 1/00

(52) U.S. Cl. 379/394

(57) ABSTRACT

In a bidirectional transmission system including an I/O circuit, an I/O circuit, and a bidirectional transmission path which connects the circuits together, a variable impedance circuit is provided at an input end of the circuit connected to the transmission path. First transmission information (an output signal from the circuit) is sent from the circuit to the circuit via the transmission path as a voltage signal. Second transmission information (an impedance control signal from the variable impedance circuit) is sent from the circuit to the circuit via the transmission path as a voltage signal. The second transmission information is transmitted to the circuit as a change in the voltage signal which corresponds to a change in the circuit impedance Z of the variable impedance circuit.

### CROSS-REFERENCE TO RELATED APPLICATIONS

This application is based upon and claims the benefit of priority from Japanese Patent Application No. 2005-368104, filed Dec. 21, 2005, the entire contents of which are incorporated herein by reference.

### BACKGROUND

1. Field

The invention relates to a bidirectional transmission device that transmits information in two directions and a related bidirectional transmission method. In particular, the invention relates to a bidirectional transmission device and a bidirectional transmission method which are used to transmit multivalued digital information in two directions along the same transmission path, for example, between individual devices or inside LSI.

2. Description of the Related Art

To transmit a digital signal, conventional techniques convert the target signal into a voltage signal according to its level (for two values, an H and L levels, and for more levels, the H and L levels as well as intermediate levels) and apply the voltage signal to a signal line. A receiver then detects the voltage signal. This scheme has long been commonly utilized in electronic circuits for digital signals and is widely used in current personal computers and digital AV equipments.

This transmission scheme requires at least one signal line as a transmission path and requires two signal lines to allow a transmitter and a receiver to transmit signals to and from each other. In other words, bidirectional transmissions require twice as many signal lines as those for unidirectional transmissions. For example, signal transmissions that require 128 signal lines for unilateral transmissions require 128×2=256 signal lines for bidirectional transmissions. Then, if a large number of signal lines are provided in a CPU bus or between a disk drive and a main body circuit board, the number of signal lines and wiring area disadvantageously increase.

To cope with this problem, a bidirectional transmission device has been proposed (Jpn. Pat. Appln. KOKAI Publication No. 2002-016487). A bidirectional transmission device 20a shown in FIG. 2 of this document converts a signal to be transmitted to a receiver via a driver 21a, into a voltage signal according to its level. The bidirectional transmission device 20a then transmits the voltage signal to a signal line 31. On this occasion, first current detecting circuits 22a and 22b detect the direction of a current flowing through the signal line 31. A determination circuit 24a determines the level of the receiver on the basis of the current direction and the level of the signal transmitted to the receiver. The receiving transmission device 20b makes a similar determination. For example, if two devices transmit signals to and from each other, they can carry out transmissions during the same period without an increase in the number of signal lines.

An object of the invention is to provide a bidirectional transmission device and a bidirectional transmission method which are adapted for an increased information transmission rate.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram illustrating the configuration of a bidirectional transmission device according to a first embodiment of the invention;

FIGS. 2A, 2B, 2C and 2D are diagrams, each of which illustrates an example of the waveform of signals transmitted by the bidirectional transmission device according to the first embodiment of the invention;

FIG. 3 is a diagram illustrating an input impedance varying circuit for the bidirectional transmission device according to the first embodiment of the invention;

FIGS. 4A, 4B, 4C and 4D are diagrams, each of which illustrates an example of a step response from the bidirectional transmission device according to the first embodiment of the invention (reflected waves vary depending on impedance);

FIG. 5 is a diagram illustrating the configuration of a bidirectional transmission device according to a second embodiment of the invention (an example in which reflected waves are latched);

FIG. 6 is a diagram illustrating another example 1 of an input impedance varying circuit for the bidirectional transmission device;

FIG. 7 is a diagram illustrating another example 2 of an input impedance varying circuit for the bidirectional transmission device; and

FIG. 8 is a diagram illustrating another example 3 of an input impedance varying circuit for the bidirectional transmission device.

### DETAILED DESCRIPTION

Various embodiments according to the invention will be described hereinafter with reference to the accompanying drawings. In general, according to one embodiment of the invention, a bidirectional transmission device comprises a first I/O circuit, a second I/O circuit, and a bidirectional transmission path which connects the first I/O circuit and the second I/O circuit together, wherein a variable impedance circuit is provided at an input end of the second I/O circuit connected to the bidirectional transmission path, first transmission information is sent from the first I/O circuit to the second I/O circuit via the bidirectional transmission path as a first voltage signal, second transmission information is sent from the second I/O circuit to the first I/O circuit via the bidirectional transmission path as a second voltage signal, and the second transmission information is transmitted to the first I/O circuit as a change in the second voltage signal which corresponds to a change in the circuit impedance of the variable impedance circuit.

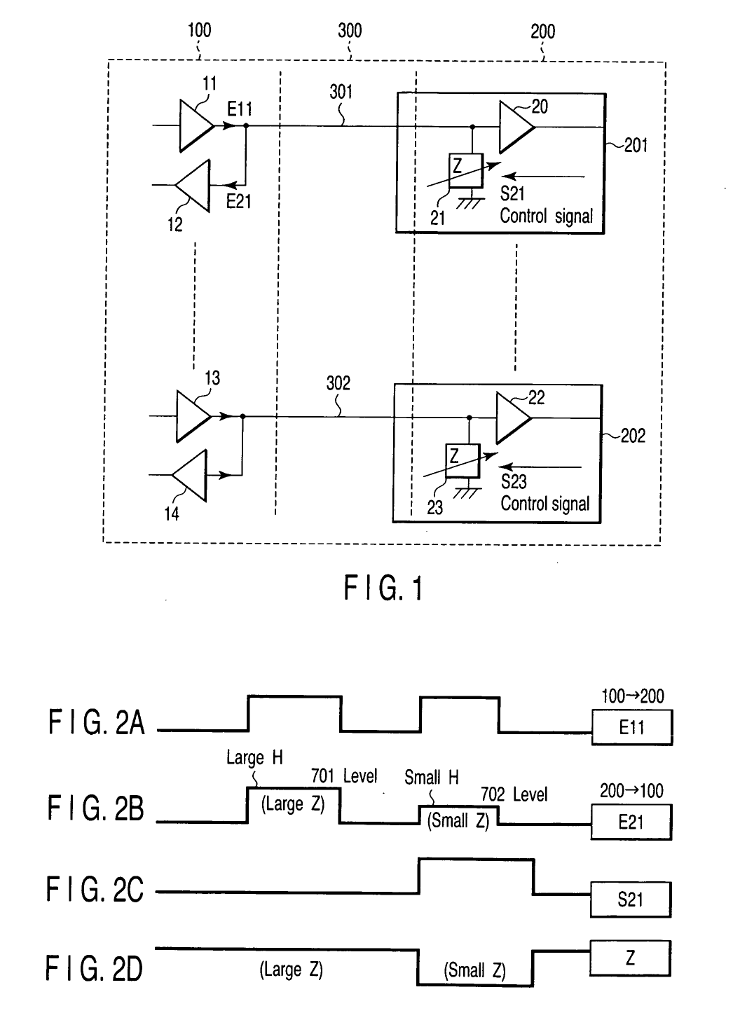

FIG. 1 is a diagram illustrating the configuration of a bidirectional transmission device (bidirectional logic circuit) according to an embodiment of the present invention. In the circuit configuration shown in FIG. 1, a plurality of data transmissions are carried out between a first I/O circuit (one side of a bidirectional transmission system) 100 and a second I/O circuit (the other side of the bidirectional transmission system) 200 via a bidirectional transmission path 300. The bidirectional transmission path 300 is composed of at least one bidirectional transmission lines 301, 302, . . . , and may be wiring between devices for digital signals or inside LSI.

The first I/O circuit 100 is composed of output circuits (drivers) 11, 13, . . . and input circuits (comparators or the like which determine predetermined logic levels) 12, 14, . . . each connected to one end of a corresponding one of the transmission lines 301, 302, . . . . The second I/O circuit 200 is composed of I/O circuits (drivers) 201, 202, . . . each connected to the other end of a corresponding one of the transmission lines 301, 302, . . . . Each of the I/O circuits 201, 202, . . . is composed of a reception circuit (receiver) 20, 22, . . . and a variable impedance circuit 21, 23, . . . .

For example, for the bidirectional transmission line 301 in the bidirectional transmission line 300 in the configuration shown in FIG. 1, a signal E11 from the output circuit 11 is input to the reception circuit 20 of the I/O circuit 201 via the bidirectional transmission line 301 to transmit signal information. The input impedance Z (corresponding to the terminal impedance ZL of the transmission line 301) of the I/O circuit 201 is determined by the variable impedance circuit 21. The input impedance Z can be changed via a control signal S21. That is, the input impedance Z varies depending on the logic state (in other words, signal information to be transmitted from the second I/O circuit 200 to the first I/O circuit 100) of the signal S21, which controls the variable impedance circuit 21.

FIGS. 2A, 2B, 2C and 2D are diagrams, each of which illustrates an example of illustrating an example of the waveform of signals transmitted by the bidirectional transmission device according to the embodiment of the invention. The axis of abscissa in each of FIGS. 2A, 2B, 2C and 2D indicates time, and the axis of ordinate indicates a signal level or the magnitude of impedance. The waveform E11 in FIG. 2A illustrates signal information to be sent from the first I/O circuit 100 to the second I/O circuit 200. A waveform E21 in FIG. 2B illustrates signal information to be sent from the second I/O circuit 200 to the first I/O circuit 100. A waveform S21 in FIG. 2C illustrates the input impedance (or the terminal impedance ZL of the transmission path 300) of the second I/O circuit 200 controlled depending on the logic level of the signal S21.

In this example, it is assumed that when the signal information (S21) to be sent from the second I/O circuit 200 to the first I/O circuit 100 is at a high level, the input impedance Z is low and that when the signal information (S21) is at a low level, the input impedance Z is high. In this case, the waveform of the signal E21 shown in FIG. 2B is such that when the input impedance Z of the second I/O circuit 200 is high, the signal E21 is at a high level such as a level 701 and that when the input impedance Z is low, the signal E21 is at, for example, a level 702 that is lower than the level 701. This difference in the level of the signal E21 (between the relatively high level 701 and the relatively low level 702) can be detected by a comparator (window comparator or the like) that determines a predetermined level (corresponding to the level 701 or 702). Each of the input circuits 12, 14, . . . in the first I/O circuit 100 may include such a comparator.

Consequently, a signal transmission from the first I/O circuit 100 to the second I/O circuit 200 and a signal transmission in the opposite direction, that is, from the second I/O circuit 200 to the first I/O circuit 100, can be simultaneously carried out on the same transmission path 300.

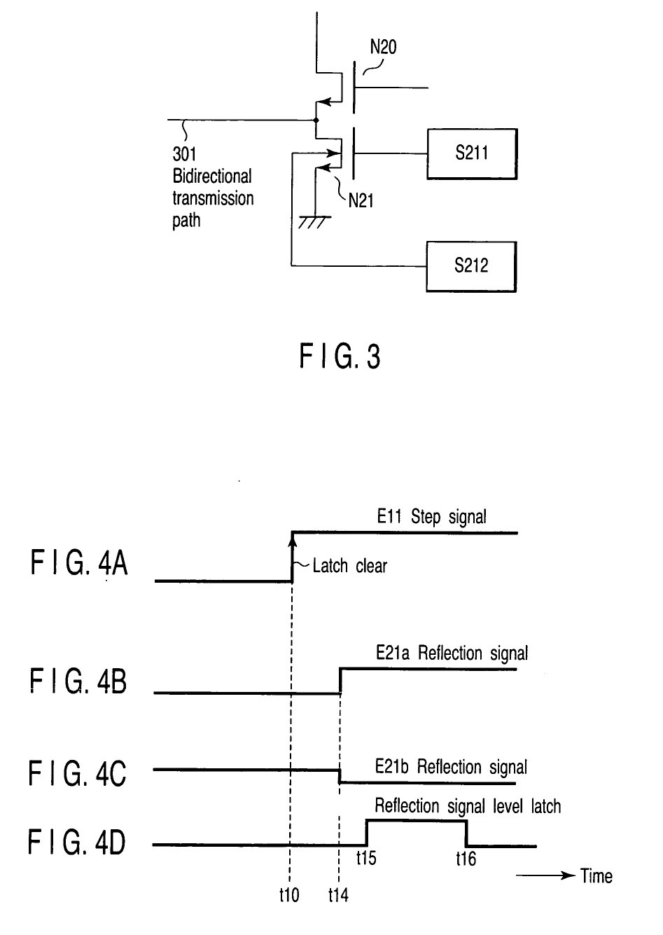

FIG. 3 is a diagram illustrating an input impedance varying circuit for the bidirectional transmission device according to the embodiment of the present invention. This figure shows an example of a circuit with a field effect transistor which varies the internal impedance depending on the logic state (voltage level) of signal information (S211 and/or S212: corresponds to S21 in FIG. 1) to be transmitted from the second I/O circuit 200 to the first I/O circuit 100.

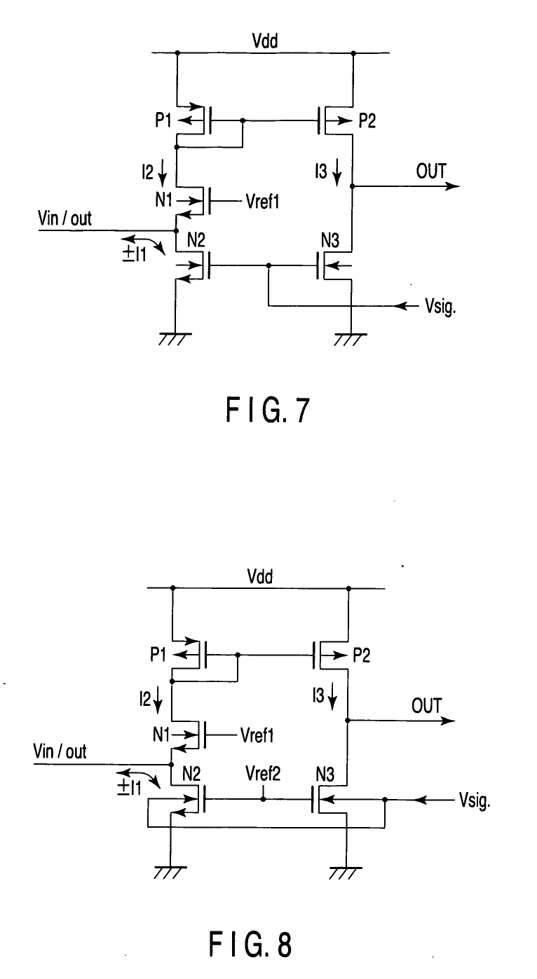

N20 and N21 in FIG. 3 denote N-channel MOS transistors having a source and drain connected to an input and output terminals, respectively, of each terminal line (for example, the bidirectional transmission line 301) in the bidirectional transmission line 300. The transistor N20 performs a gate grounding operation and has a gate connected to, for example, a circuit (for an alternate current, a grounding circuit) providing a reference voltage Vref1 as shown in FIG. 7. The I/O terminal impedance of the bidirectional transmission line 301 can be varied by the potential of a signal S211 at a gate control terminal. Specifically, raising the potential of the signal S211 (the gate voltage of the N-channel MOS transistor N21) increases the drain current value of the N-channel MOS transistor N21 and thus the current value of the transistor N20 cascaded to the transistor N21. The impedance (impedance seen looking from the transmission path) at the connection between the transistors N21 and N20 is almost equal to the source impedance of N20 and has a value that can be represented by the inverse of mutual conductance gm of N20. Accordingly, increasing the magnitude of the current through N20 reduces the impedance. On the contrary, lowering the potential of the signal S211 reduces the drain current values of the MOS transistor N21 and N20, while increasing the impedance of the transistor N20.

Thus, the source terminal impedance of the transistor N21, that is, the I/O terminal impedance of the bidirectional transmission line 301 (corresponding to the terminal impedance of the transmission line 301), can be varied by the potential of the signal S211 (gate voltage of the N-channel MOS transistor N21). This can also be achieved by varying the potential of the control signal S212, provided to the back gate of the transistor N21. A drain current through the MOS transistor N21 can be controlled by the difference between potential between gate voltage (S211) and back gate voltage (S212). The I/O terminal impedance of the bidirectional transmission line 301 (in FIG. 1, the internal impedance Z of the variable impedance circuit 21) can be varied on the basis of the combination of logic levels of the signal S211 and/or signal S212.

FIGS. 4A, 4B, 4 and 4D are diagrams, each of which illustrates an example of a step response from the bidirectional transmission device according to the embodiment of the present invention (an example in which reflected waves vary as a result of impedance mismatch). The step signal E11 in FIG. 4A corresponds to a signal applied to the bidirectional transmission line 301 by the output circuit 11 shown in FIG. 1. The signal E11 in FIG. 4 has a very rapid rise (for example, a rise time on the order of several 100 ps). With the configuration in FIG. 1, when the characteristic impedance of each transmission line (for example, the bidirectional transmission line 301) in the bidirectional transmission line 300 is defined as Zo and the input impedance of the I/O circuit 201 is defined as ZL, the reflection coefficient r of a signal at the input point of the I/O circuit 201 can be generally given by:

Γ=(ZL−Zo)/(ZL+Zo)

If ZL>Zo, the reflection signal of the step signal E11 is generated on the positive side, like a reflection signal E21a in FIG. 4B. On the contrary, If ZL<Zo, the reflection signal of the step signal E11 is generated on the negative side, like a reflection signal E21b in FIG. 4C. That is to say, even for high-speed transmissions (for example, a rise time on the order of several 100 ps), information can be bidirectionally transmitted by utilizing the polarity of the reflection signal corresponding to the logic level of the variable impedance control signal S21. In this case, when the signal E11 to be transmitted and its reflection signal E21a or E21b are present on the transmission path 300 at the same time, the waveform observed at the reception point in the first I/O circuit 100 corresponds to the synthesis (sum) of the transmission signal E11 and the reflection signal E21a or E21b. In this case, the synthetic signal level varies depending on the polarity of the reflection. The varied level can thus be identified by the window comparator or the like to sense the information transmitted from the second I/O circuit 200 to the first I/O circuit 100.

By using a clock of a predetermined period instead of such a step signal as shown in FIG. 4A, the I/O circuit 100 can sense the transmission information corresponding to the reflection signal (logic state of the variable impedance control signal in the I/O circuit 200) synchronizing with that clock.

Further, in Equation (1), adjusting the impedance so that Γ=0 (impedance matching) enables the use of three values (multiple values), +, −, and ±0, as the polarity of reflected waves.

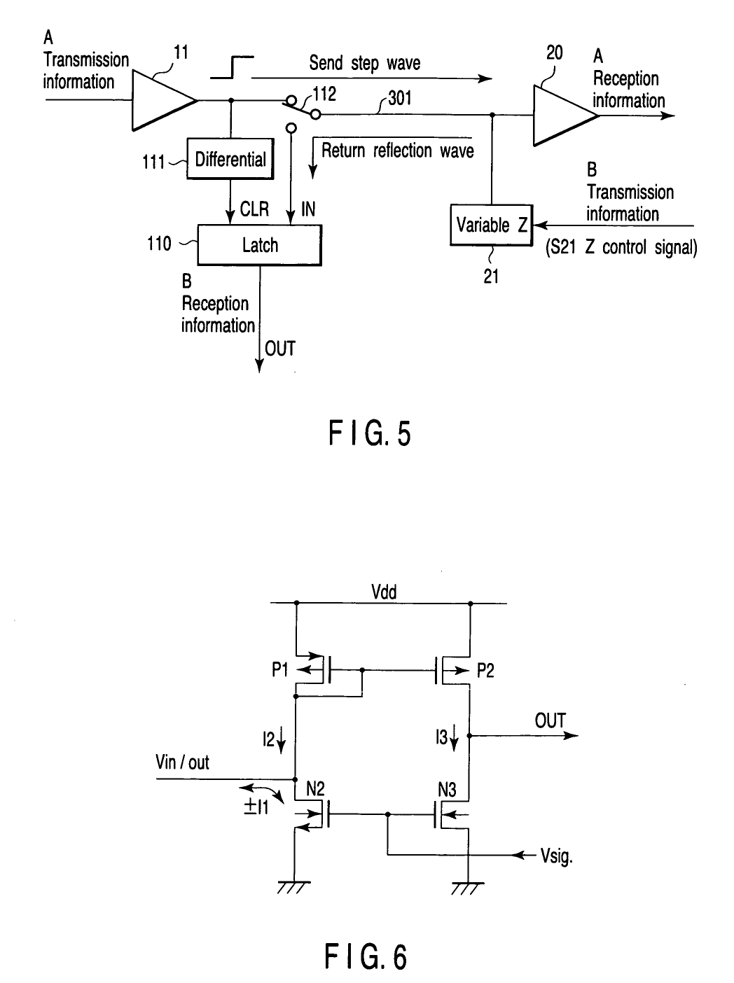

FIG. 5 is a diagram illustrating the configuration of a bidirectional transmission device according to another embodiment of the present invention (an example in which reflected waves are latched). In this example, when the signal E11 to be transmitted and its reflection signal (E21a or 21b in FIG. 4) are not present on the transmission path 300 (for example, the transmission path 301) at the same time, the information transmitted from the second I/O circuit 200 to the first I/O circuit 100 can be sensed.

When transmission information A is input to the output circuit 11, the step signal E11 (FIG. 4A) corresponding to the information A is transmitted to the transmission line 301 via a high-speed electronic switch 112. A rise in the step signal E11 is extracted by a differential circuit 111. A latch 110 is cleared at the rise timing (t10) of the signal E11.

The logic level (information A) of a transmission signal from the output circuit 11 is received by the reception circuit 20 as reception information A. When transmission information B is input to the variable impedance circuit 21 simultaneously with the transmission of the information A, reflection of the polarity corresponding to the information B occurs. Reflection signal (E21a in FIG. 4B or E21b in FIG. 4C) from the transmission line 301 is input to the latch circuit 110 via the high-speed electronic switch 112. Once the transmission line 301 is physically and electrically designed, the amount of time from the transmission of the step signal until the return of the reflection signal can be predetermined (to be a design center with a certain variation taken into account or on the basis of the average of actual measurements of a plurality of preproduction prototypes). This makes it possible to determine the timing (t15) at which the reflection signal is latched after the corresponding step signal has been transmitted (t10). The signal level of the reflection signal (E21a in FIG. 4B or E21b in FIG. 4C) can thus be latched at that timing (t15). After the latching, the selection of the switch 112 returns to the output circuit 11 (t16). However, the latched information remains in the latch circuit 110. This enables the first I/O circuit 100 to retrieve the information B transmitted by the second I/O circuit 200.

FIG. 6 is a diagram illustrating another example 1 of an input impedance varying circuit for the bidirectional transmission device. This example corresponds to a specific example of the circuit shown in FIG. 3 and is a basis for the circuit shown in FIGS. 7 and 8, described below. In the circuit example shown in FIG. 6, P-channel MOS transistors P1 and P2 form a current mirror. The same gate voltage (Vsig) is provided for N-channel MOS transistors N2 and N3. If a current ±I1 resulting from Vin from the transmission path 300 or Vout to the transmission path 300 is zero, I2 and I3 are equal to each other owing to a 1:1 current mirror operation. This relationship (I2=I3) remains unchanged even if Vsig is changed to increase the magnitude of a current through the transistors N2 and N3.

An increase in the magnitude of the current I2 varies the impedance of the transistor P1 with its gate and drain connected together; the value of the impedance is almost equal to 1/gm (an increase in the magnitude of I2 increases gm of the transistor P1, thus reducing the value of 1/gm). This enables the impedance at the Vin/out node to be varied depending on the magnitude of the gate voltage Vsig (corresponding to the logic level of the control signal S21).

If a signal (transmitted by the first I/O circuit 100) enters Vin/out to change the current ±I1, that change corresponds to a change in I2, that is, a change in I3. However, since the current through the transistor N3 is determined by Vsig, the change in the current ±I1 is output as a change in OUT shown in the figure.

FIG. 7 is a diagram illustrating another example 2 of an input impedance varying circuit for the bidirectional transmission device. This example corresponds to the circuit configuration in FIG. 6 to which the N-channel MOS transistor N1 with its gate grounded at the reference voltage Vref1 is added. The added N-channel MOS transistor N1 enables the DC potential of the Vin/out terminal (that is, the connected transmission path 300) to be adjusted by the reference voltage Vref1. This enables the transistors P1 and N2 to operate at a desired operation point. In this case, the impedance at the Vin/out terminal corresponds to the source impedance of the transistor N1.

FIG. 8 is a diagram illustrating another example 3 of an input impedance varying circuit for the bidirectional transmission device. This example corresponds to the circuit configuration in FIG. 7 in which the gates of the N-channel MOS transistors N2 and N3 are connected to a reference voltage Vref2 to connect the signal information Vsig to be transmitted to each of back gates of the transistors N2 and N3. This configuration is advantageous in that the drain current is less sensitive to a change in back gate potential than to a change in gate potential (that is, the drain current is insensitive to the set level of Vsig) and is thus advantageous for generating Vsig and that Vsig may be fixed at any potential in a mode using only one direction (instead of two directions) in which a logic signal is received from the first I/O circuit 100 (rightward in the illustrated circuit).

### Effects of the Embodiments

Bidirectional transmissions can be achieved by adding the variable impedance circuit only to one end (one side) of the transmission path. The present invention thus requires only a relatively simple circuit configuration. The variable impedance circuit itself consumes little power and does not require any complicated adjustments. That is, the invention uses the simplified circuit to provide a bidirectional transmission device which requires reduced power consumption and only simple adjustments. The invention also utilizes reflection waves for high-speed signals to provide a bidirectional transmission device which requires reduced power consumption and which can operate at high speeds.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A bidirectional transmission device comprising a first I/O circuit, a second I/O circuit, and a bidirectional transmission path which connects the first I/O circuit and the second I/O circuit together,
wherein a variable impedance circuit is provided at an input end of the second I/O circuit connected to the bidirectional transmission path,
first transmission information is sent from the first I/O circuit to the second I/O circuit via the bidirectional transmission path as a first voltage signal,
second transmission information is sent from the second I/O circuit to the first I/O circuit via the bidirectional transmission path as a second voltage signal, and
the second transmission information is transmitted to the first I/O circuit as a change in the second voltage signal which corresponds to a change in the circuit impedance of the variable impedance circuit.

2. The device according to claim 1, wherein the second I/O circuit includes a circuit which detects a change in the level of the second voltage signal resulting from the change in circuit impedance.

3. The device according to claim 1, further comprising a reflection signal detecting circuit which detects a reflection signal, wherein if the first voltage signal sent from the first I/O circuit to the second I/O circuit via the bidirectional transmission path is reflected by the variable impedance circuit to return to the first I/O circuit as the reflection signal,
when the characteristic impedance of the bidirectional transmission path is defined as ZL and the circuit impedance of the variable impedance circuit is defined as Zo, the reflection signal changes depending on whether ZL is larger or smaller than Zo.

4. The device according to claim 1, wherein the variable impedance circuit comprises a transistor circuit which has an internal impedance which varies in association with a gate voltage and/or a back gate voltage.

5. The device according to claim 2, wherein the variable impedance circuit comprises a transistor circuit which has an internal impedance which varies in association with a gate voltage and/or a back gate voltage.

6. The device according to claim 3, wherein the variable impedance circuit comprises a transistor circuit which has an internal impedance which varies in association with a gate voltage and/or a back gate voltage.

7. The device according to claim 1, wherein the transistor has a threshold which varies depending on the back gate voltage and is configured so that whether the gate voltage is larger or smaller than the threshold corresponds to the second transmission information.

8. The device according to claim 2, wherein the transistor has a threshold which varies depending on the back gate voltage and is configured so that whether the gate voltage is larger or smaller than the threshold corresponds to the second transmission information.

9. The device according to claim 3, wherein the transistor has a threshold which varies depending on the back gate voltage and is configured so that whether the gate voltage is larger or smaller than the threshold corresponds to the second transmission information.

10. The device according to claim 4, wherein the transistor has a threshold which varies depending on the back gate voltage and is configured so that whether the gate voltage is larger or smaller than the threshold corresponds to the second transmission information.

11. The device according to claim 5, wherein the transistor has a threshold which varies depending on the back gate voltage and is configured so that whether the gate voltage is larger or smaller than the threshold corresponds to the second transmission information.

12. The device according to claim 6, wherein the transistor has a threshold which varies depending on the back gate voltage and is configured so that whether the gate voltage is larger or smaller than the threshold corresponds to the second transmission information.

13. A method for a bidirectional transmission system comprising one side of the bidirectional transmission system, the other side of the bidirectional transmission system, and a bidirectional transmission path which connects the one side of the bidirectional transmission system to the other side of the bidirectional transmission system,
wherein first transmission information is sent from the one side of the bidirectional transmission system to the other side of the bidirectional transmission system via the bidirectional transmission path as a first voltage signal,
second transmission information is sent from the other side of the bidirectional transmission system to the one side of the bidirectional transmission system via the bidirectional transmission path as a second voltage signal, and
the second transmission information is transmitted to the one side of the bidirectional transmission system as a change in the second voltage signal which corresponds to a change in the circuit impedance at an input end of the other side of the bidirectional transmission system which is connected to the bidirectional transmission path.
